(19) United States
(12) Patent Application Publication
(10) Pub. No.: US 2024/0239020 A1
(43) Pub. Date: Jul. 18, 2024

(54) DRYING INSTALLATION FOR GRANULAR POLYMER MATERIAL

(71) Applicant: PEGASO INDUSTRIES S.P.A., Borgoricco (PD) (IT)

(72) Inventor: Rinaldo PIVA, Borgoricco (PD) (IT)

(73) Assignee: PEGASO INDUSTRIES S.P.A., Borgoricco (PD) (IT)

(21) Appl. No.: 18/560,157

(22) PCT Filed: May 10, 2022
(86) PCT No.: PCT/IB2022/054326

§ 371 Date: Nov. 10, 2023

(30) Foreign Application Priority Data
May 11, 2021 (IT) 102021000012095

(51) Int. Cl. B29B 13/06; F26B 3/06; F26B 21/12

(52) U.S. Cl. CPC B29B 13/065; F26B 3/06; F26B 21/12; F26B 2200/08

(57) ABSTRACT

A drying installation for granular polymer material includes a hopper, in which the granular polymer material is dried, and a supply circuit for a process gas which is provided to dry the granular polymer material. The drying installation also includes a turbofan which is able to rotate an impeller of the turbofan at a speed of at least 7000 rpm and which is provided to move the process gas along the supply circuit towards the hopper.

### TECHNICAL FIELD

The present invention relates to a drying installation for granular polymer material.

### TECHNOLOGICAL BACKGROUND

The present invention is used, particularly though in a non-exclusive manner, in industrial processes for converting plastics materials into granules by extrusion or moulding.

These operations are generally carried out in a transforming machine, in which the polymer material is brought to the molten or semi-molten state before being introduced into a mould or being extruded.

In order to ensure an adequate level of quality of the final product, however, it is necessary for the polymer material which is supplied to the transforming machine to have to be free from humidity to the greatest possible extent. Furthermore, this requirement is difficult to reconcile with the high levels of hygroscopic properties of some plastics materials in common use, such as, for example, the ones based on polyethylene terephthalate (PET) or polyamide (PA) or polycarbonate (PC) or some copolymers, such as ABS (acrylonitrile butadiene styrene).

Mainly for this purpose, but also in order to reduce the quantity of energy necessary to bring the polymer material to the molten or semi-molten state inside the transforming machine, it is known to process the granules beforehand in suitable drying installations, where the water content of the granules is reduced to the minimum quantities required by the transforming process.

An example of a known drying installation provides for the granular polymer material to be processed inside a hopper which is positioned immediately upstream of the transforming machine, in which there is introduced a continuous flow of a hot process gas, where applicable with a low content of humidity, which provides for desorbing the water from the polymer material. The process gas, which is typically air, is introduced into the hopper through a suitable supply circuit where the process gas is brought to the most suitable conditions for efficiently drying the polymer material.

In particular, the supply circuit may comprise a heating unit for bringing the process gas to a desired temperature and, where applicable, a dehumidification unit for reducing the humidity content of the gas to a predefined value.

The process gas is introduced into hoppers with a predefined flow rate, propelled along the supply circuit by a movement unit and controlled by a flow regulation unit.

Furthermore, in quite a common embodiment, the process gas introduced into the hopper is recovered at the discharge and recirculated after being filtered. The Applicant has observed that, in the known drying installations, the energy necessary for moving the process gas along the supply circuit and inside the hopper constitutes a highly relevant fraction of the total energy used in the drying process.

In particular, the Applicant has found that this fraction is between 20% and 30% of the total energy, in some cases also reaching 40%.

Therefore, the Applicant has perceived that an increase in the energy efficiency of the movement unit has a significant impact on improving the energy efficiency of the entire drying installation.

Therefore, the Applicant has previously verified that, in the conventional installations, the movement unit is typically based on using one or more blowers, for example, of the side channel type.

The Applicant has further verified that movement devices of this type have a number of disadvantages as a result of operating limitations in terms of flow rate and regulation possibilities.

In particular, the Applicant has found that, in order to address the gas flow rates required by the drying process, it is often necessary to operate with two blowers in parallel, which may involve a series of complications in terms of management and control of the blowers, as well as, naturally, in terms of installation and maintenance costs.

In the present description and the appended claims, the term “granular material” is intended to be a plurality of solid elements which are different and separate from each other and which have suitable dimensions and shapes, in accordance with the processing operation to be carried out and the polymer material used, including polymer material in powdered or flaked form.

Furthermore, the term “drying” is intended to be the process as a result of which the humidity content of the granular polymer material is reduced to the desired values requested by the subsequent transforming process (moulding or extrusion). In accordance with the type of polymer material being processed, the water to be removed may be mainly the water present on the external surface of the granules or may also be the water present, where applicable, in the internal regions of the granules.

### DESCRIPTION OF THE INVENTION

The problem addressed by the present invention is to provide a drying installation for granular polymer material which is structurally and functionally configured to comply with the requirement set out above by at least partially overcoming the disadvantages set out above with reference to the cited prior art.

In particular, an object of the present invention is to provide a drying installation which reduces the energy input required to move the process gas along the supply circuit and inside the hopper.

Another object of the invention is to provide a drying installation in which the movement unit for the process gas is simple to construct and easy to control.

The problem indicated above are solved and the objects indicated above are achieved by the present invention by means of a drying installation comprising one or more of the features set out in the appended claims.

In a first aspect thereof, the present invention is directed to a drying installation for granular polymer material, comprising a hopper, in which the granular polymer material is dried, and a supply circuit for a process gas which is connected to the hopper and which is configured to supply a process gas to the hopper in order to dry the granular polymer material.

The supply circuit comprises a turbofan which is provided to move the process gas along the supply circuit towards the hopper.

As a result of the features set out above, the drying installation of the present invention has a substantial increase in energy efficiency.

In particular, the Applicant has found that using a turbofan as the movement unit for the process gas along the supply circuit also allows a reduction of 50% in the energy input necessary for moving the gas.

A turbofan differs from the conventional blowers in that the impeller can be rotated at a higher number of revolutions per minute, for example, it may reach from 12,000 to 15,000 rpm as compared with approximately 3000 for a conventional blower.

In the context of the present description and the appended claims, the term “turbofan” is intended to be understood to be a movement device for the air which is capable of rotating the impeller at a speed of at least 7000 rpm, preferably at least 10,000 rpm, even more preferably at least 12,000 rpm.

Generally, a turbofan also has an impeller which is formed differently from the impeller of a blower.

The turbofan is also called a “turboblower” and the two terms are understood herein to have the same meaning.

Turbofans are known per se and are mainly used in very different sectors, including the processing of plastics materials, such as, for example, the sector of engines for motor vehicles and the sector of purifying water.

The Applicant has further found that using a turbofan has a number of other advantages with respect to using a conventional blower.

For example, the turbofan, for the same performance levels, is more compact and allows simpler connection to the supply and inlet pipes. Furthermore, the turbofan is a simple device to control and heats up less during use.

Another characteristic advantage of the turbofan involves the possibility of working in flow ranges which are greater with respect to the blower and it particularly allows maximum flow rates which are generally higher to be reached.

As a result of this advantageous characteristic, therefore, it is possible in some applications to use a single turbofan in place of two blowers in a parallel arrangement, with an immediate and clear saving including in terms of the cost of acquisition and installation, in addition to the energy consumption during use.

In the aspect described above, the present invention may further have at least one of the preferred features described below.

In a preferred embodiment, the turbofan comprises a motor and an impeller which is directly coupled to the motor.

In this manner, the impeller is rotated directly by the motor, without any need for providing transmission and/or reduction systems of the movement, with a resultant saving in terms of components and increase in the efficiency of movement transmission.

Preferably, the motor is an electric motor and is associated with a device for varying the frequency of the electric current (an inverter) so as to vary the rotation speed of the motor.

It is thereby possible to regulate the rotation speed of the impeller and, consequently, the flow rate of the process gas.

Preferably, the turbofan is configured to operate up to a maximum number of revolutions per minute of 12,000 rpm, more preferably of 15,000 rpm.

Preferably, the turbofan is configured to operate with a head between 100 and 250 mbar.

Preferably, the turbofan is configured to operate up to a maximum flow rate between 900 and 4000 m³/h.

In one embodiment, the supply circuit comprises a heating unit which is configured to heat the process gas.

In one embodiment, the supply circuit comprises a dehumidification unit which is configured to reduce the humidity content of the process gas.

In one embodiment, the supply circuit is a closed circuit.

Preferably, the granular polymer material is based on polyethylene terephthalate (PET).

### BRIEF DESCRIPTION OF THE DRAWINGS

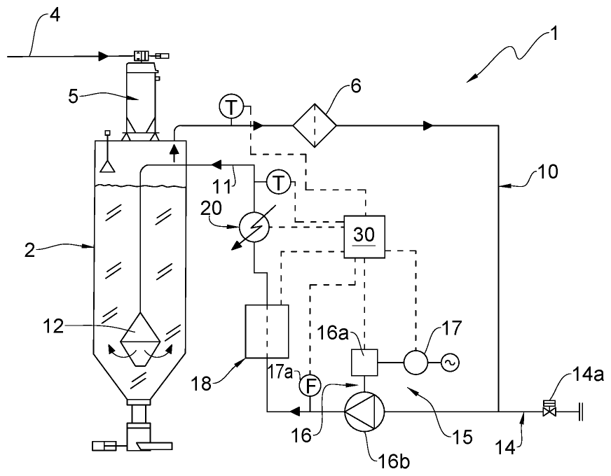

The features and advantages of the invention will be better appreciated from the detailed description of a preferred embodiment thereof which is illustrated by way of non-limiting example with reference to the appended drawing, in which the single FIG. 1 is a schematic view of a drying installation for granular polymer material constructed according to the present invention.

### PREFERRED EMBODIMENT OF THE INVENTION

In the FIGURE, a drying installation for granular polymer material constructed according to the present invention is designated, as a whole, with 1. The installation 1 comprises a hopper 2, inside which the material to be dried is introduced. This material may be any polymer material in granules, for example, polyamide, polycarbonate or ABS copolymer even if, in the preferred embodiment described here, the material processed is formed by granules of polyethylene terephthalate (PET), a fraction of which may result from recycled PET.

The installation 1 is provided to supply a transforming machine for the granular polymer material (not shown), such as, for example, a press or an extruder, which is positioned downstream of the hopper 2.

In the embodiment described herein, there is provided a single hopper 2 but there may also be provided two or more hoppers which are arranged in series or in parallel.

The installation 1 comprises a charging line 4 which is provided to charge the granular polymer material to be dried in the hopper 2 by means of a supply hopper 5.

The installation 1 further comprises a supply circuit 10 which is associated with the hopper 2 and which is configured to introduce therein a hot and dry process gas which, by passing through the granular material contained in the hopper 2, is able to reduce the degree of humidity thereof to the desired levels which are adequate for the subsequent steps of processing the polymer material.

The process gas is typically air but may also be an inert gas without any oxygen.

In particular, the supply circuit 10 introduces the process gas into the hopper 2 through an inlet pipe 11, at the internal end of which with respect to the hopper 2 a diffuser 12 is mounted.

After passing through the granular polymer material which is contained in the hopper 2, the process gas is recovered at the discharge from the top of the hopper 2 by a discharge pipe 13 of the supply circuit 10.

There is preferably mounted on the discharge pipe 13 a filtration device 6, for example, a separation cyclone, which is configured to separate the process gas from any powder which is drawn from the interior of the hopper 2. The discharge pipe 13 is therefore connected to the inlet pipe 11 in order to place the process gas which is discharged from the hopper 2 back into circulation. A reintegration line 14 which is controlled by a valve 14a is further provided to reintegrate, where necessary, the process gas present in the supply circuit 10 with fresh process gas.

The supply circuit 10 further comprises a movement unit 15 which is provided to move the process gas along the supply circuit 10.

In particular, according to a main aspect of the invention, the movement unit 15 comprises a turbofan 16.

The turbofan 16 comprises an electric motor 16a and an impeller 16b which is coupled to the motor 16a. The impeller 16b is coupled directly to the motor 16a without any movement transmission systems.

The movement unit 15 further comprises an inverter 17 which is connected to the motor 16a in order to vary the frequency of the supply current of the electric motor. The inverter 17, by regulating the number of revolutions of the motor and therefore the number of revolutions of the impeller, in fact acts as a regulation device for the flow rate of the process gas to be introduced into the hopper 2.

A flow measuring member 17a is preferably provided downstream of the inverter 17 in order to measure the gas flow rate effectively passing along the pipe 11 and to allow the accurate regulation thereof by means of the inverter 17.

The turbofan 16 is suitably selected in accordance with the flow rate necessary to dry the granular polymer material adequately inside the hopper 2 and may, for example, be configured to operate at a maximum flow rate of approximately 4000 m³/h with a head of approximately 200 mbar.

The supply circuit 10 further comprises a dehumidification unit 18 which is positioned downstream of the movement unit 15 and which is configured to dehumidify the process gas up to predefined absolute humidity values (for example, corresponding to a dew point of the process gas between −30° C. and −50° C.) and which are suitable for drying the granular polymer material inside the hopper 2.

The provision of the dehumidification unit 18 is a function of the polymer material being processed, in particular the hygroscopicity thereof. In the case of PET, the presence thereof in the supply circuit of the process gas is generally required.

The dehumidification unit 18 may be of any type known in the sector and, for example, may comprise a pair of towers which are mutually identical and which each contain a suitable quantity of drying compound, for example, molecular sieves, which are connected to each other in parallel so as to be selectively and alternately connected to the supply circuit 10.

The dehumidification degree of the process gas can be measured downstream of the dehumidification unit 18 and is preferably able to be regulated by acting on the operating conditions of the towers.

The supply circuit 10 further comprises a heating unit 20 which is positioned downstream of the dehumidification unit 18 and which is provided to heat the process gas to the predefined temperature for introduction into the hopper 2, for example, to approximately 180° C.

A control unit 30 is further configured to control and regulate the entire drying process carried out in the installation 1. In particular, the control unit 30 is connected to the inverter 17 and the flow measuring member 17a, the electric motor 16a, the dehumidification unit 18, the heating unit 20, the charging line 4 and the valve 14a in the reintegration line 14.

The installation 1 operates in the manners described below.

The granular polymer material is charged by means of the charging line 4 into the hopper 2, where it is dried by means of contact with the process gas which is introduced into the hopper 2 through the supply circuit 10.

The process gas is moved along the supply circuit 10 as a result of the action of the movement unit 15, which further provides for regulating the flow rate of the process gas as a result of the action of the inverter 17 on the motor 16a. The process gas is therefore dehumidified in the dehumidification unit 18 and is then brought to the heating unit 20, where it is heated to the desired temperature before being introduced into the hopper 2.

The process gas is then introduced into the hopper 2 through the inlet pipe 11 and the diffuser 12 and then brought back into the supply circuit 10 by means of the outlet pipe 13 and then again to the movement unit 15.

The use of the turbofan 16 in the movement unit 15 allows relevant advantages to be obtained with respect to conventional installations, particularly in terms of energy consumption of the movement unit.

By way of example, the Applicant has verified that, in a drying installation such as the one described above and configured to dry approximately 1000 kg/h of PET, the total energy required (in one hour) would be approximately 75 KWh, of which approximately from 35% to 40% would be required by a movement unit with conventional blowers, while in an installation constructed according to the present invention, with a turbofan in place of the blowers, the total energy required (in one hour) would be approximately 60 KWh, of which approximately 25% is required by the movement unit.

Another advantage is that a turbofan generally allows a maximum flow rate greater than the rate of a blower to be obtained. This becomes particularly relevant when the flow rate of process gas to be conveyed into hoppers is similar to or slightly greater than the maximum flow rate of a blower. In this case, in fact, it would be necessary to provide two blowers in parallel while in the installation according to the invention a single turbofan will be sufficient to supply the desired flow rate of gas.

In the case of drying PET, the Applicant has verified that this condition occurs when the flow rate of polymer material to be dried is between 800 and 1000 kg/h.

The drying installation 1 therefore allows the granular polymer material contained in the hopper 2 to be dried in an optimum manner, at the same time achieving a relevant reduction in the energy input required for the drying thereof.

The invention thereby solves the problem set out, further allowing additional advantages to be afforded, including containing the costs of installation and maintenance.

1. A drying installation (1) for granular polymer material, comprising:
a hopper (2), in which the granular polymer material is dried,
a supply circuit (10) for a process gas which is connected to the hopper and which is configured to supply a process gas to the hopper (2) in order to dry the granular polymer material and
wherein the supply circuit comprises a turbofan (16) which is able to rotate at a speed of at least 7000 rpm and which is provided to move the process gas along the supply circuit (10) towards the hopper (2).

2. The installation (1) according to claim 1, wherein the turbofan (16) comprises a motor (16a) and an impeller (16b) which is directly coupled to the motor (16a).

3. The installation (1) according to claim 2, wherein the motor (16a) is an electric motor and is associated with a device (17) for varying the frequency of the electric current so as to vary the rotation speed of the motor.

4. The installation (1) according to claim 2, wherein the turbofan (16) is configured to rotate the impeller up to a maximum number of revolutions per minute of 15,000 rpm.

5. The installation (1) according to claim 1, wherein the turbofan (16) is configured to operate with a head between 100 and 250 mbar.

6. The installation (1) according to claim 1, wherein the turbofan (16) is configured to operate up to a maximum flow rate between 900 and 4000 m³/h.

7. The installation (1) according to claim 1, wherein the supply circuit (10) comprises a heating unit (20) which is configured to heat the process gas.

8. The installation (1) according to claim 1, wherein the supply circuit (10) is a closed circuit.
